(19) United States
(12) Patent Application Publication
(10) Pub. No.: US 2010/0073389 A1
(43) Pub. Date: Mar. 25, 2010

(54) Display device

(75) Inventors: Kozo Yasuda, Chiba (JP); Toshio Miyazawa, Chiba (JP); Hiroyuki Abe, Chiba (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi Displays, Ltd., Chupei City (JP)

(21) Appl. No.: 12/591,594

(22) Filed: Nov. 24, 2009

Related U.S. Application Data
(63) Continuation of application No. 11/378,309, filed on Mar. 20, 2006.

(30) Foreign Application Priority Data
Apr. 5, 2005 (JP) 2005-108329

(51) Int. Cl. G09G 5/00; G06F 12/02

(52) U.S. Cl. 345/565; 345/214

(57) ABSTRACT

In a display device which arranges a memory part for every display pixel, an erroneous operation of the memory part and the power consumption can be reduced. In a display device provided with a display panel which includes a plurality of display pixels, video lines which apply video data to the display pixels, and scanning lines which apply a scanning voltage to the display pixels, the display pixel includes a memory part which stores the video data, a pixel electrode, and a switching part which selectively applies a first video voltage or a second video voltage which differs from the first video voltage to the pixel electrode in response to the video data stored in the memory part.

### CROSS REFERENCE TO RELATED APPLICATIONS

This application is a Continuation Application of U.S. application Ser. No. 11/378,309 filed on Mar. 20, 2006. The present application claims priority from U.S. application Ser. No. 11/378,309 filed on Mar. 20, 2006, which claims priority from Japanese Application 2005-108329 filed on Apr. 5, 2005, the content of which is hereby incorporated by reference into this application.

### BACKGROUND OF THE INVENTION

1. Field of the Invention

The present invention relates to a display device such as a liquid crystal display device or an EL display device, and more particularly to a display device which arranges a memory for every display element.

2. Description of the Related Art

There has been known a liquid crystal display device capable of exhibiting the small power consumption and high functions which arranges a memory in each display pixel within a liquid crystal display panel, stores display data in the memory and displays an image on the liquid crystal display panel even when there is no input signals from the outside (See Japanese Patent Laid-open 2003-108031 (patent document 1)).

FIG. 11 is an equivalent circuit diagram showing the constitution of one display pixel of a conventional liquid crystal display panel, and also is an equivalent circuit diagram showing the constitution of one display pixel described in the above-mentioned patent document 1.

In the drawing, a first inverter circuit (INV1) and a second inverter circuit (INV2) constitute a memory part.

In a state that a control line (L1) assumes a High level (hereinafter a H level) and an n-type MOS transistor (hereinafter, simply referred to as an n-type transistor) (TR6) assumes an ON state, when a selective scanning voltage is applied to a scanning line (also referred to as a gate line) (G), an n-type transistor (TR1) is turned on and a p-type MOS transistor (hereinafter simply referred to as p-type transistor) (TR2) is turned off and hence, data (“1” or “0”) applied to a video line (D) is written in a node 1 (node1).

Next, when a non-selective scanning voltage is applied to the scanning line (G), the n-type transistor (TR1) is turned off and the p-type transistor (TR2) is turned on and hence, data which is written in the node 1 (node1) is held in the memory part which is constituted of the first inverter circuit (INV1) and the second inverter circuit (INV2).

For example, in the above-mentioned constitution shown in FIG. 11, with respect to the liquid crystal display panel which adopts a normally white mode, when “1” is written in the node 1 (node1) (“0” being written in a node 2 (node2)), the liquid crystal display panel performs a “black” display, while when “0” is written in the node 1 (node1) (“1” being written in the node 2 (node2)), the liquid crystal display panel performs a “white” display.

### SUMMARY OF THE INVENTION

In the above-mentioned FIG. 11, control voltages having polarities opposite from each other are applied to the control line (L1) and a control line (L2).

Further, in the constitution shown in FIG. 11, as an AC driving method of the liquid crystal display panel, a common inversion driving method is adopted. In this driving method, when a video voltage of positive polarity is applied to a pixel electrode, the H-level voltage is applied to the control line (L1) and the low-level (L-level) voltage is applied to the control line (L2) and hence, the transistor (TR6) is turned on and the transistor (TR7) is turned off. On the other hand, when a video voltage of negative polarity is applied to a pixel electrode, the L-level voltage is applied to the control line (L1) and the H-level voltage is applied to the control line (L2) and hence, the transistor (TR6) is turned off and the transistor (TR7) is turned on.

Accordingly, in the constitution shown in FIG. 11, when the polarity of the video voltage applied to the pixel electrode is changed by changing the polarity of the control voltage applied to the control line (L1) and the control line (L2), the video voltage is simultaneously written in the display pixel part through the first inverter circuit (INV1) and the second inverter circuit (INV2).

That is, when the polarity of the video voltage applied to the pixel electrode is changed, a charging current flows in a holding capacitance (Cadd) through the first inverter circuit (INV1) or the second inverter circuit (INV2), while a discharging current flows out from a holding capacitance (Cadd) through the first inverter circuit (INV1) or the second inverter circuit (INV2).

In this manner, since the charging current simultaneously flows in the holding capacitances (Cadd) or the discharging current simultaneously flows out from the holding capacitances (Cadd), not only the increase of the power consumption, there also arises a drawback that noises are generated and the memory part causes an erroneous operation.

The present invention is made to overcome the above-mentioned drawbacks of the related art and it is an advantage of the present invention to provide a technique which can reduce an erroneous operation of a memory part and can reduce the power consumption in a display device which arranges the memory part for every display pixel.

The above-mentioned advantages and other advantages of the present invention and novel features will become apparent from the description of the specification and attached drawings.

To explain the summary of typical inventions among the inventions disclosed in this specification, they are as follows.

(1) In a display device which includes a display panel having a plurality of display pixels, video lines which apply video data to the display pixels, and scanning lines which apply a scanning voltage to the display pixels; wherein

the display pixel includes a memory part which stores the video data, a pixel electrode, and a switching part which selectively applies a first video voltage or a second video voltage which differs from the first video voltage to the pixel electrode in response to the video data stored in the memory part.

(2) In the constitution (1), the display device includes a common electrode which faces the pixel electrodes in an opposed manner and the first video voltage is applied to the common electrode.

(3) In the constitution (2), the magnitude of the first video voltage and the magnitude of the second video voltage are changed over from each other in a predetermined cycle.

(4) In any one of constitutions (1) to (3), in a state that the video data stored in the memory part is held, the memory part includes a first inverter circuit which has an input terminal thereof connected to a first node and an output terminal thereof connected to a second node, and a second inverter circuit which has an input terminal thereof connected to the second node and an output terminal thereof connected to the first node.

(5) In the constitution (4), the display pixel further includes a first switching element which is turned off when a non-selective scanning voltage is applied to the scanning line, is turned on when a selective scanning voltage is applied to the scanning line and applies the video data which is applied to the video line to the first node, and a second switching element which is connected between the first node and the output terminal of the second inverter circuit, and is turned off when the selective scanning voltage is applied to the scanning line, and is turned on when the non-selective scanning voltage is applied to the scanning line.

(6) In the constitution (4) or (5), the switching part includes a third switching element which is turned off when a voltage of the first node assumes a second state and is turned on when the voltage of the first node assumes a first state so as to apply the first video voltage to the pixel electrode, and a fourth switching element which is turned off when a voltage of the second node assumes the second state and is turned on when the voltage of the second node assumes the first state so as to apply the second video voltage to the pixel electrode.

(7) In the constitution (4) or (5), the switching part includes a third switching element which has a gate thereof connected to the first node, has a first terminal thereof to which the first video voltage is supplied, and has a second terminal thereof connected to the pixel electrode, and a fourth switching element which has a gate thereof connected to the second node, has a first terminal thereof to which the second video voltage is supplied, and has a second terminal thereof connected to the pixel electrode, and a conductive type of the third switching element and a conductive type of the fourth switching element are equal.

(8) In any one of the constitutions (1) to (7), the display device includes a video line shift register circuit which selects the video line to which the video data is to be supplied, and a scanning line shift register circuit which selects the scanning line to which the scanning voltage is to be supplied.

(9) In the constitution (8), the video line shift register circuit and the scanning line shift register circuit are integrally formed on the same substrate on which the memory parts of the display panel are formed.

(10) In any one of the constitutions (1) to (7), the display device includes a video line address circuit which selects the display pixel to which the video data is to be written, and a scanning line address circuit which selects the scanning line to which the scanning voltage is to be supplied.

(11) In the constitution (10), the video line address circuit and the scanning line address circuit are integrally formed on the same substrate on which the memory parts of the display panel are formed.

(12) In any one of the constitutions (1) to (11), the display device includes an inverter which generates the second video voltage by inverting the first video voltage.

(13) In any one of the constitutions (1) to (12), one sub pixel is constituted of M pieces of the display pixels.

(14) In the constitution (13), M pieces of the display pixels which constitute the one sub pixel have areas of the respective pixel electrodes made different from each other.

(15) In the constitution (14), the video data is formed of m(m≧2)-bit video data, the M is the m, and the areas of the pixel electrodes of the M pieces of the respective display pixels which constitute the one sub pixel are weighed at a ratio of 1:2: . . . :(2^{m-1}).

(16) In any one of the constitutions (13) to (15), the video line which applies the video data to the one sub pixel is divided in j (j≦2), and the video data is applied by time division for every j pieces of display pixels in the one sub pixel due to the j-divided video lines.

(17) In any one of the constitutions (13) to (16), the scanning line which applies the scanning voltage to the one sub pixel is divided in k (k≧2), and the scanning voltage is applied by time division for every (M/k) pieces of display pixels in the one sub pixel due to the k-divided video lines.

(18) In any one of the constitutions (1) to (17), the display device is a liquid crystal display device.

The above-enumerated constitutions merely form some examples of the present invention and the present invention is not limited to the above-mentioned constitutions and various modifications can be made without departing from the gist of the present invention.

To briefly explain advantageous effects obtained by the typical inventions among the inventions disclosed in this specification, they are as follows.

According to the present invention, in the display device which arranges the memory part for every display pixel, it is possible to reduce the erroneous operations of the memory part and the power consumption.

### BRIEF DESCRIPTION OF THE DRAWINGS

FIG. 1 is a block diagram showing the schematic constitution of a liquid crystal display device of an embodiment 1 of the present invention;

FIG. 2 is a view showing an equivalent circuit of a display pixel shown in FIG. 1;

FIG. 3 is a view showing the relationship between a voltage of VCOM of the liquid crystal display device of the embodiment 1 and a voltage of bar VCOM which is obtained by inverting the voltage of VCOM of the embodiment of the present invention;

FIG. 4 is a block diagram showing the schematic constitution of a liquid crystal display device of an embodiment 2 of the present invention;

FIG. 5 is a view showing an equivalent circuit of a display pixel shown in FIG. 4;

FIG. 6 is a block diagram showing the schematic constitution of a modification of the liquid crystal display device of the embodiment 2 of the present invention;

FIG. 7 is a block diagram showing the schematic constitution of a liquid crystal display device of an embodiment 3 of the present invention;

FIG. 8A and FIG. 8B are views for explaining a sub pixel of a liquid crystal display panel of the embodiment 3 of the present invention and area gray scales;

FIG. 9 is a circuit diagram showing the inner constitutions of a horizontal shift register circuit and a data latch circuit, as shown in FIG. 7;

FIG. 10 is a view showing one example of a driving timing chart of the liquid crystal display device of the embodiment 3 of the present invention; and

FIG. 11 is an equivalent circuit diagram showing the constitution of one display pixel of a conventional liquid crystal display panel.

### DESCRIPTION OF THE PREFERRED EMBODIMENTS

Hereinafter, embodiments in which the present invention is applied to a liquid crystal display device are explained in detail in conjunction with drawings.

Here, in all drawings for explaining the embodiments, parts having identical functions are given same symbols and their repeated explanation is omitted.

### Embodiment 1

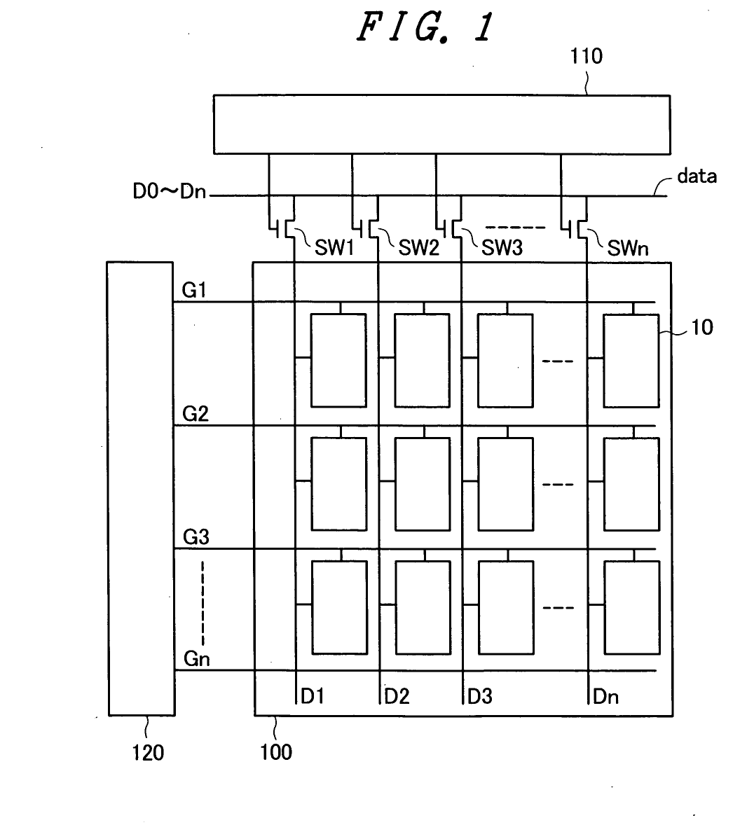

FIG. 1 is a block diagram showing the schematic constitution of a liquid crystal display device of an embodiment 1 of the present invention.

In FIG. 1, numeral 100 indicates a display part, numeral 110 indicates a horizontal shift register circuit (also referred to as a video line shift register circuit), numeral 120 indicates a vertical shift register circuit (also referred to as a scanning line shift register circuit), and numeral 10 indicates display pixels.

The display part 100 includes a plurality of display pixels 10 which are arranged in a matrix array, video lines (also referred to as drain lines) D (D1, D2, D3 . . . , Dn) which supply display data to the respective display pixels 10, scanning lines (also referred to as gate lines) G (G1, G2, G3 . . . , Gn) which supply scanning signals to the respective display pixels 10. Here, although a case in which the number of the video lines (D) is n and the number of the scanning lines (G) is n is described, the number of the video lines (D) and the number of the scanning lines (G) may be made different from each other.

FIG. 2 is a view showing an equivalent circuit of the display pixel 10 in FIG. 1.

In the drawing, a first inverter circuit (INV1) and a second inverter circuit (INV2) constitute a memory part.

In the first inverter circuit (INV1), an input terminal is connected to a first node (also referred to as a node 1) (node1) and an output terminal is connected to a second node (also referred to as a node 2) (node2). Further, in the second inverter circuit (INV2), an input terminal is connected to the second node (node2) and an output terminal is connected to the first node (node1). That is, the first inverter circuit (INV1) and the second inverter circuit (INV2) are connected to each other in a ring shape. Here, the output terminal of the second inverter circuit (INV2) is connected to the input terminal of the first inverter circuit (INV1) through a p-type transistor (TR2), wherein the p-type transistor (TR2) is turned on when the p-type transistor (TR2) is in a normal state, that is, when a memory part is in a holding operation state. Accordingly, in this specification, even when the first inverter circuit (INV1) and the second inverter circuit (INV2) are connected with each other through the transistor which is turned on with the memory part in the holding operation state, the expression “the first inverter circuit (INV1) and the second inverter circuit (INV2) are connected to each other in a ring shape” is adopted. The same goes for the expression “the output terminal of the second inverter circuit (INV2) is connected to the first node (node1)”.

A drain of an n-type transistor (TR1; a first switching element of the present invention) and a drain of the p-type transistor (TR2; a second switching element of the present invention) are connected to the node 1 (node1) and, at the same time, a gate of the n-type transistor (TR1) and a gate of the p-type transistor (TR2) are connected to a scanning line (G).

Accordingly, when a selective scanning voltage (for example, a H level) is applied to the scanning line (G), the n-type transistor (TR1) is turned on and the p-type transistor (TR2) is turned off, and data (“1” or “0”) which is applied to the video line (D) is written in the node 1 (node1). That is, the writing operation is performed.

Further, when a non-selective scanning voltage (for example, an L level) is applied to the scanning line (G), the n-type transistor (TR1) is turned off and the p-type transistor (TR2) is turned on, and a data value which is written in the node 1 (node1) is held in the memory part which is constituted of the first inverter circuit (INV1) and the second inverter circuit (INV2). That is, the holding operation is performed.

An n-type transistor (TR3; a third switching element of the present invention) which has a gate thereof connected to the first node (node1) is turned on when the voltage of the first node (node1) is at the high level, and applies a first video voltage (here, a voltage of VCOM applied to the common electrode (ITO2)) is applied to the pixel electrode (ITO1).

A n-type transistor (TR4; a fourth switching element of the present invention) which has a gate thereof connected to the second node (node2) is turned on when the second node (node2) is at the H level and hence, a second video voltage (here, a voltage of bar VCOM which is obtained by inverting the voltage of VCOM applied to the common electrode (ITO2) by an inverter) is applied to the pixel electrode (ITO1).

Here, the relationship between the first node (node1) and the second node (node2) is a relationship in which the signal level is inverted. Further, the n-type transistor (TR3) has the same conductive type as the n-type transistor (TR4). When the voltage of the first node (node1) is at the H level, the voltage of the second node (node2) is at the L level and hence, the n-type transistor (TR3) is turned on and the n-type transistor (TR4) is turned off. When the voltage of the first node (node1) is at the L level, the voltage of the second node (node2) is at the H level and hence, the n-type transistor (TR3) is turned off and the n-type transistor (TR4) is turned on.

In this manner, a switching part (for example, constituted of two transistors (TR3, TR4)) selects the first video voltage or the second video voltage in response to the data stored in the memory part (data written in the memory part form the video line (D)), and applies the selected voltage to the pixel electrode (ITO1).

Due to an electric field generated between the pixel electrode (ITO1) and the common electrode (also referred to as the counter electrode) (ITO2) which is arranged to face the pixel electrode (ITO1) in an opposed manner, the liquid crystal (LC) is driven. Here, the counter electrode (ITO2) maybe formed on the same substrate on which the pixel electrode (ITO1) is formed or may be formed on a substrate which differs from the substrate on which the pixel electrode (ITO1) is formed.

Transistors which constitute the inverter circuits (INV1, INV2) and the transistors TR1, TR2, TR3, TR4 are constituted of a thin film transistor which uses poly-silicon as a material of a semiconductor layer.

A horizontal shift register circuit 110 and a vertical shift register circuit 120 in FIG. 1 are circuits arranged in the inside of the liquid crystal display panel, wherein these circuits are, in the same manner as the transistors which constitute the inverter circuits (INV1, INV2) and the transistors TR1, TR2, TR3, TR4, are constituted of a thin film transistor which uses poly-silicon as a material of a semiconductor layer. These thin film transistors are formed simultaneously with the transistors or the like which constitutes the inverter circuits (INV1, INV2).

In this embodiment, a scanning line selective signal is outputted sequentially to the respective scanning lines (G) from the vertical shift register circuit 120 for every 1 H period (scanning period). Accordingly, the transistors (TR1) which have gates thereof connected to the respective scanning lines (G) are turned on, while the transistors (TR2) are turned off.

Further, in this embodiment, switching transistors (SW1 to SWn) are provided for every video line (D). These switching transistors (SW1 to SWn) are sequentially turned on in response to a shift output of H level which is outputted form the horizontal shift register circuit 110 within 1 H period (scanning period) thus connecting the video lines (D) and the data lines (data).

Accordingly, the data (“1” or “0”) which is applied to the video line (D) is written in the node 1 (node1) and hence, an image is displayed on the display part 100.

Further, when the non-selective scanning voltage is applied to the scanning line (G), the transistor (TR1) is turned off and the transistor (TR2) is turned on and hence, the data value which is written in the node 1 (node1) is held in the memory part which is constituted of the first inverter circuit (INV1) and the second inverter circuit (INV2). Accordingly, the image is displayed on the display part 100 even during a period in which there is no image imputing.

For example, in this embodiment, with respect to the normally-white liquid crystal display panel, when “1” is written in the node 1 (node1) (“0” being written in the node 2 (node2)), the liquid crystal display panel performs the “white” display, while when “0” is written in the node 1 (node1) (“0” being written in the node 2 (node2)), the liquid crystal display panel performs the “black” display.

When it is unnecessary to rewrite the image, the operations of the horizontal shift register circuit 110 and the vertical shift register circuit 120 can be stopped and hence, the power consumption can be reduced.

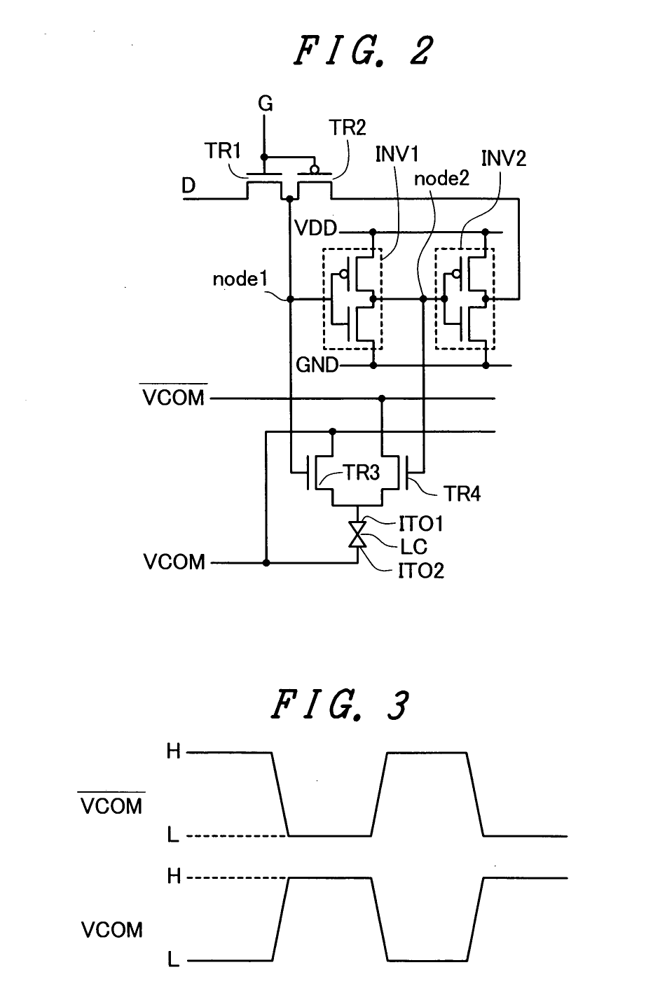

Also in this embodiment, a common inversion driving method is adopted as an AC driving method of the liquid crystal display panel. In this embodiment, as shown in FIG. 3, it is sufficient to change only a voltage of VCOM (a first video voltage) and a voltage of bar VCOM which is obtained by inverting the voltage of VCOM (a second video voltage) corresponding to the common inversion cycle. The voltage of VCOM is inverted between an L level (for example, 0V) and an H level (for example, 5V) corresponding to the common inversion cycle. The voltage of bar VCOM can be generated by inverting the voltage of VCOM using an inverter. When the voltage of VCOM is at the L level, the voltage of the bar VCOM is at the H level, while when the voltage of VCOM is at the H level, the voltage of the bar VCOM is at the L level. That is, the magnitude of the voltage of the VCOM and the magnitude of the voltage of the bar VCOM are changed over from each other at the predetermined cycle.

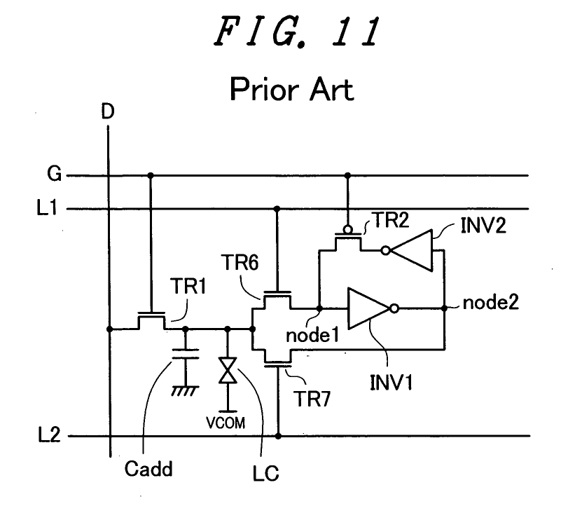

In this embodiment, different from the constitution shown in FIG. 11, there is no possibility that when the polarity of the video voltage applied to the pixel electrode is changed, a charging current simultaneously flows into the holding capacitance (Cadd) through the inverter circuit (INV1) or the inverter circuit (INV2) or a discharging current simultaneously flows out from the holding capacitance (Cadd) through the inverter circuit (INV1) or the inverter circuit (INV2) and hence, it is possible to realize the reduction of the erroneous operations of the memory part attributed to the generation of noises and the reduction of power consumption.

Further, in this embodiment, the holding capacitance (Cadd) shown in FIG. 11 is unnecessary and hence, it is possible to increase a numerical aperture of each display pixel. Further, since the holding capacitance (Cadd) is unnecessary, a writing load to the pixel electrode is small whereby the power consumption can be reduced. Further, with respect to the constitution shown in FIG. 11, the writing of the data into the memory part is performed only when the control line (L1) is at the H level. However, in this embodiment, the writing of data and the inversion cycle of the common inversion driving method can be made independent from each other and hence, it is possible to provide the liquid crystal display device which is simple and possesses the high general-use property. Since it is unnecessary to synchronize the common inversion cycle with the writing of data, the cycle and the timing of the common inversion can be arbitrarily predetermined. The common inversion cycle may be predetermined to, for example, every one frame, every one line (every scanning period), every plurality of lines (every plurality of scanning periods) or may be set to an arbitrary period besides the above periods.

### Embodiment 2

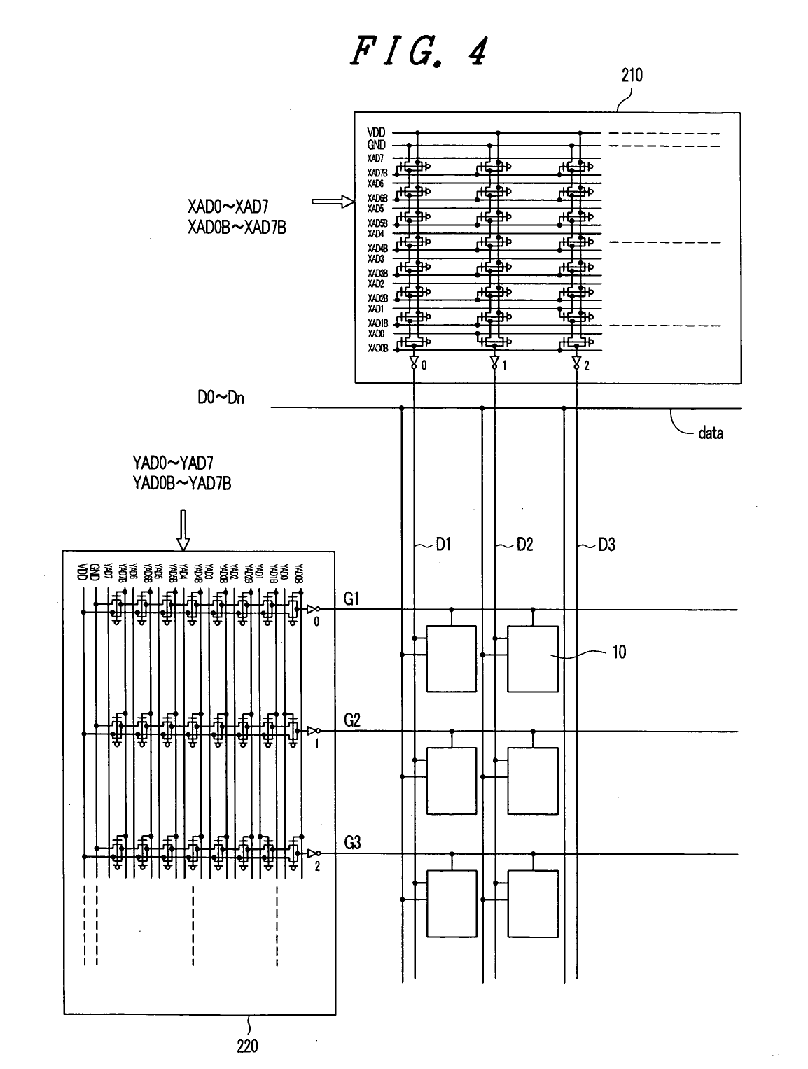

FIG. 4 is a block diagram showing the schematic constitution of a liquid crystal display device according to an embodiment 2 of the present invention.

This embodiment is characterized by using an X-address circuit (also referred to as a video line address circuit) 210 and a Y-address circuit (also referred to as a scanning line address circuit) 220 in place of the horizontal shift register circuit 110 and the vertical shift register circuit 120 shown in FIG. 1. The explanation is made hereinafter by focusing on constitutions which make this embodiment different from the above-mentioned embodiment 1.

Both of the X-address circuit 210 and the Y-address circuit 220 are constituted of rows of n-type MOS transistors and p-type MOS transistors. To allow the selection of the scanning line (G) or the video line (D) in response to an address to be inputted, gates of the respective transistors are connected with predetermined address lines.

Symbols XAD0B to XAD7B are inverted pulses of XAD0 to XAD7, while YAD0B to YAD7B are inverted pulses of YAD0 to YAD7. In FIG. 4, an example in which the pulse has 8-bit information is shown. Accordingly, the numbers of scanning lines (G) and the video lines (D) are respectively and selectively increased to n=2⁸=256. The data is inputted to a memory part of each display pixel 10 directly.

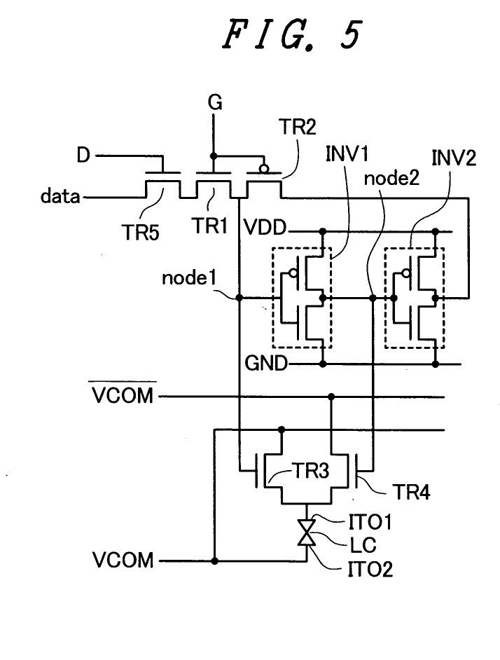

FIG. 5 is a view showing an equivalent circuit of the display pixel 10 shown in FIG. 4.

The equivalent circuit shown in FIG. 5 differs from the equivalent circuit shown in FIG. 2 with respect to points that an n-type transistor (TR5) is connected to an n-type transistor (TR1) in series, a gate of the n-type transistor (TR5) is connected to the video line (D), and a source of the n-type transistor (TR5) is connected to a data line (data).

In this embodiment, the Y-address circuit 220 selects the predetermined scanning line (G) in response to the inputted address (YAD0 to YAD7, YAD0B to YAD7B), and outputs a selection scanning voltage to the selected scanning line (G). Accordingly, the n-type transistor (TR1) which has the gate thereof connected to the selected scanning line (G) is turned on and the p-type transistor (TR2) is turned off.

In the same manner, the X-address circuit 210 selects the predetermined video line (D) in response to the inputted address (XAD0 to XAD7, XAD0B to XAD7B) and hence, the n-type transistor (TR5) which has the gate thereof connected to the selected video line (D) is turned on.

Accordingly, data (“1” or “0”) which is applied to the data line (data) is written in a node 1 (node1) of the selected display pixel 10 and hence, the image is displayed on the display part 100 even during the period in which there is no inputting of image.

Also in this embodiment, it is possible to make the inversion cycle of the voltage of VCOM applied to a common electrode (ITO2) and the writing of data independent from each other.

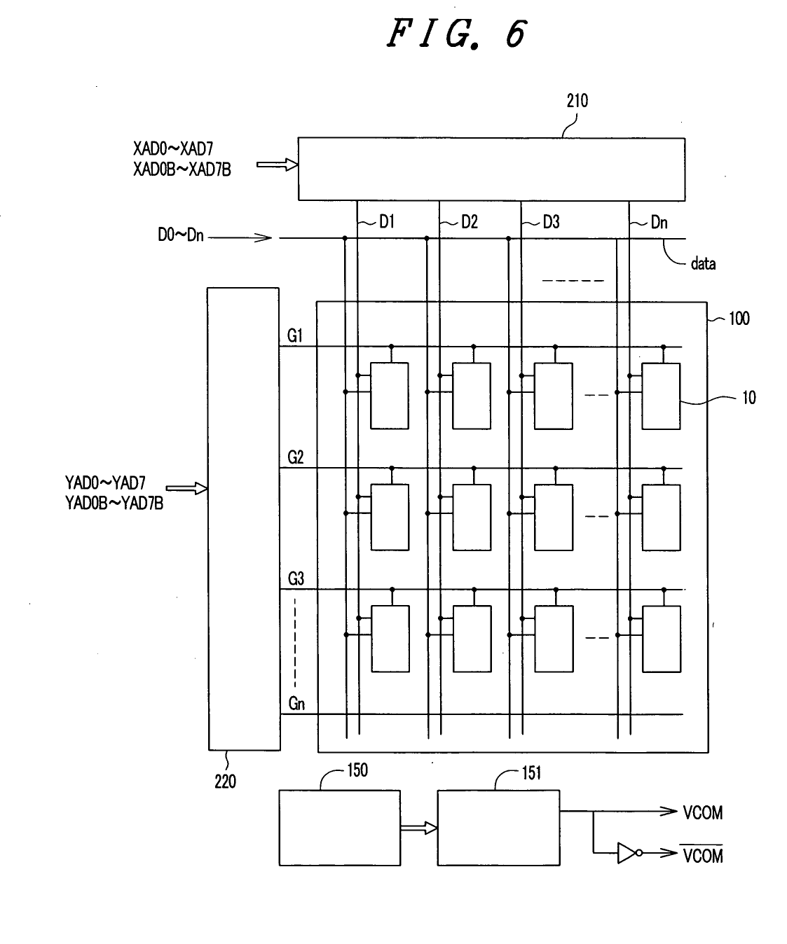

Accordingly, as shown in FIG. 6, a common voltage generating circuit which is constituted of an oscillation circuit 150 and a frequency dividing circuit 151 may be incorporated in the inside of a liquid crystal display panel for generating a voltage of VCOM which is applied to a common electrode (ITO2). A voltage of bar VCOM can be generated by inverting the voltage of VCOM using an inverter.

Further, in this embodiment, it is unnecessary to take into consideration whether the voltage of the VCOM is at an H level or at an L level and it is sufficient to input data and address at the time of writing data and hence, it is possible to display an image on the liquid crystal display panel with feeling substantially equal to feeling necessary at the time of using a usual SRAM memory.

Accordingly, the common voltage generating circuit also functions as a buffer memory of the image and hence, the image memory can be reduced.

### Embodiment 3

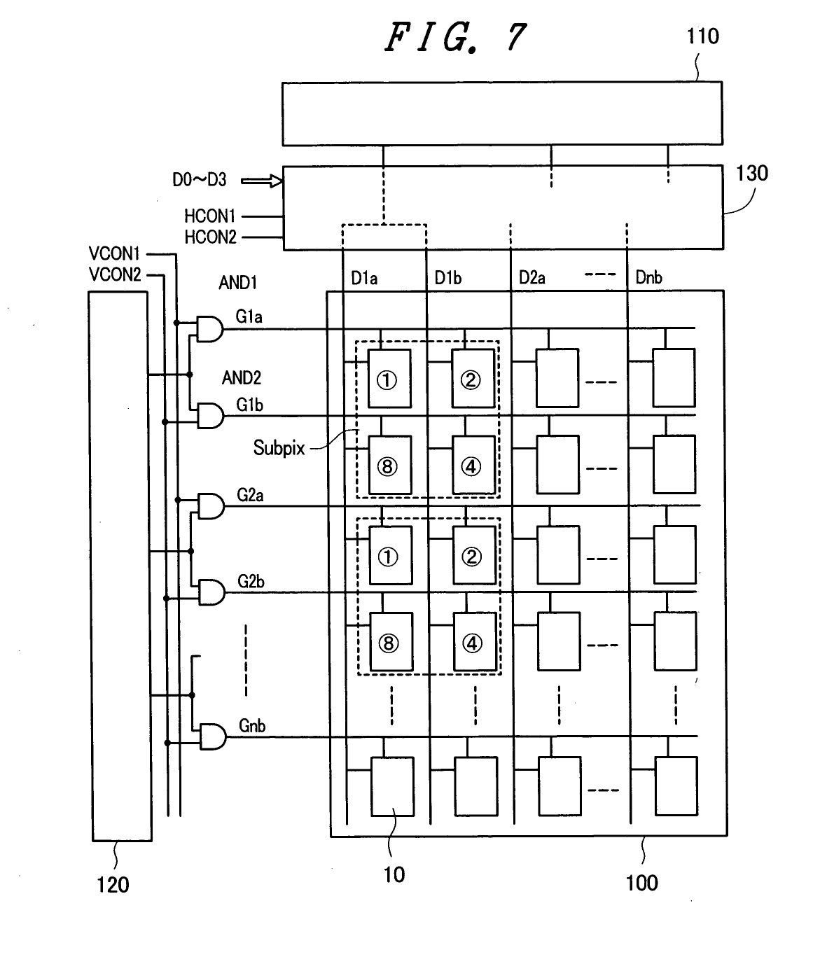

FIG. 7 is a block diagram showing the schematic constitution of a liquid crystal display device of an embodiment 3 of the present invention.

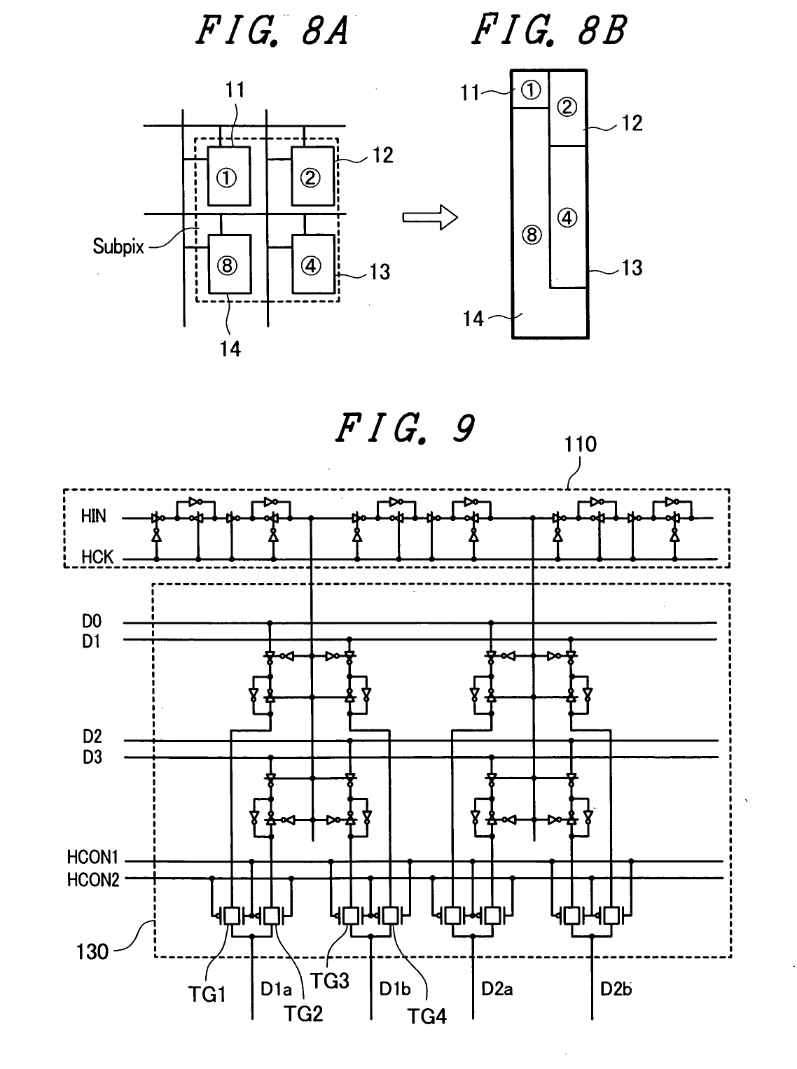

This embodiment is an embodiment which adopts an area gray scale. As shown in FIG. 8A, in this embodiment, one sub-pixel (Subpix) is constituted of four display pixels (11 to 14).

Here, as shown in FIG. 8B, with respect to four display pixels (11 to 14) which constitute one sub-pixel (Subpix), the predetermined weighting is applied to areas of pixel electrodes (ITO1).

In the example shown in FIG. 8B, the display data is formed of 4-bit display data (D0, D1, D2, D3), wherein the areas of the pixel electrodes (ITO1) of four display pixels (11 to 14) are substantially determined at a ratio of 1 (=2⁰):2 (=2¹):4 (=2²):8 (=2³).

Here, data on D0 in the 4-bit display data (D0, D1, D2, D3) is inputted to the display pixel 11. In the same manner, data on D1 in the 4-bit display data is inputted to the display pixel 12, data on D2 in the 4-bit display data is inputted to the display pixel 13, and data on D3 in the 4-bit display data is inputted to the display pixel 14.

In the examples shown in FIG. 8A and FIG. 8B, equivalent circuits of four display pixels (11 to 14) are substantially equal to the equivalent circuit 12 shown in FIG. 2 and hence, the repeated explanation of the equivalent circuit is omitted.

Further, as shown in FIG. 7, in this embodiment, a selective scanning voltage and data are inputted to four display pixels (11 to 14) which constitute one sub-pixel (Subpix) respectively and hence, one video line (D) shown in FIG. 1 is divided into two video lines Da, Db and, at the same time, one scanning line (G) shown in FIG. 1 is divided into two scanning lines Ga, Gb.

Further, a data latch circuit 130 is provided between a horizontal shift register circuit 110 and a display part 100.

FIG. 9 is a circuit diagram showing the internal constitution of the horizontal shift register circuit 110 and the data latch circuit 130 shown in FIG. 7.

The horizontal shift register circuit 110 is operated in response to a start pulse (HIN) and a clock (HCK).

The inputted 4-bit display data (D0, D1, D2, D3) is latched sequentially in the data latch circuit 130 within 1 H period (scanning period) in response to a shift output of H level outputted from the horizontal shift register circuit 110.

The data latched in the data latch circuit 130 is inputted in the memory part twice. This control is performed in response to control signals HCON1, HCON2, VCON1, VCON2.

When the control signal (HCON1) assumes the H level and the control signal (HCON2) assumes the L level, the gate circuits (TG1, TG4) are turned on, the data on D0 in the 4-bit display data (D0, D1, D2, D3) is outputted to the video lines (D1a to Dna) from the data latch circuit 130 and, at the same time, the data on D1 in the 4-bit display data (D0, D1, D2, D3) is outputted to the video lines (D1b to Dnb).

In synchronism with such an operation, the control signal (VCON1) assumes the H level and the control signal (VCON2) assumes the L level and hence, the scanning line selective signal from the vertical shift register circuit 120 is outputted to one of the scanning lines (G1a to Gna) through an and circuit (AND1) whereby the data D0 in the 4-bit display data (D0, D1, D2, D3) is inputted to the display pixel 11, and the data on D1 in the 4-bit display data (D0, D1, D2, D3) is inputted to the display pixel 12.

Further, when the control signal (HCON1) assumes the L level and the control signal (HCON2) assumes the H level, the gate circuits (TG2, TG3) are turned on, the data on D3 in the 4-bit display data (D0, D1, D2, D3) is outputted to the video lines (D1a to Dna) from the data latch circuit 130 and, at the same time, the data on D2 in the 4-bit display data (D0, D1, D2, D3) is outputted to the video lines (D1b to Dnb).

In synchronism with such an operation, the control signal (VCON1) assumes the L level and the control signal (VCON2) assumes the H level and hence, the scanning selective signal from the vertical shift register circuit 120 is outputted to one of the scanning lines (G1b to Gnb) through an and circuit (AND2) whereby the data D3 in the 4-bit display data (D0, D1, D2, D3) is inputted to the display pixel 14, and the data on D2 in the 4-bit display data (D0, D1, D2, D3) is inputted to the display pixel 13.

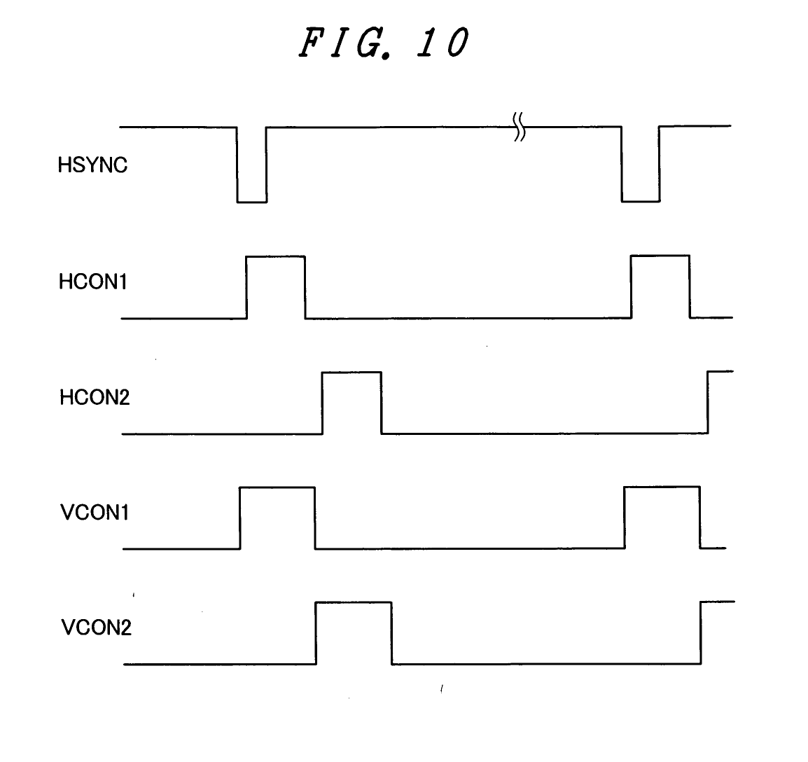

FIG. 10 shows one example of a driving timing chart of this embodiment.

During a period in which the control signal (HCON1) assumes the H level and the control signal (VCON1) assumes the H level, the data on D0 in the 4-bit display data (D0, D1, D2, D3) is outputted to the video lines (D1a to Dna), and the data on D1 in the 4-bit display data (D0, D1, D2, D3) is outputted to the video lies (D1b to Dnb). These data are inputted to the display pixel 11 and the display pixel 12 among four display pixels (11 to 14) which constitute one sub-pixel (Subpix).

Next, during a period in which the control signal (HCON2) assumes the H level and the control signal (VCON2) assumes the H level, the data on D3 in the 4-bit display data (D0, D1, D2, D3) is outputted to the video lines (D1a to Dna), and the data on D2 in the 4-bit display data (D0, D1, D2, D3) is outputted to the video lies (D1b to Dnb). These data are inputted to the display pixel 14 and the display pixel 13 among four display pixels (11 to 14) which constitute one sub-pixel (Subpix).

It is preferable to perform the above-mentioned data transfer processing within a blanking period ranging from an end of the preceding 1 H period (the falling of the horizontal synchronizing signal (HSYNC) in FIG. 10) to the inputting of the next signal. In this case, after the data transfer processing, that is, after the falling of the control signals (HCON, VCON2), the next signal (the next 4-bit display data (D0, D1, D2, D3)) is inputted at the timing not shown in the drawing, and the signal is latched sequentially by the data latch circuit 130 in response to the shift output of H level outputted from the horizontal shift register circuit 110.

Here, in the description made heretofore, the explanation is made with respect to the case in which the display data has the 4-bit information. However, when the display data has the m (m≦2)-bit information, the number of display pixels which constitute one sub-pixel (Subpix) becomes m pieces. In this case, the weighting of areas of pixel electrodes may be performed based on a ratio of 2⁰:2¹:, . . . ,:2(^{m-1}). The method of dividing the scanning line (G) and the video line (D) maybe suitably changed. For example, although it is preferable to divide the video lines (D) in three when the display data adopts m=6-bits, the scanning lines (G) may be divided in three.

Further, in the above-mentioned respective embodiments, the explanation has been made with respect to the case in which the present invention is applied to the liquid crystal display device. However, the present invention is not limited to such a case and it is needless to say that the present invention is applicable to an EL display device (an organic EL display device) or the like.

It is possible to apply the embodiment on the area gray scale which is explained in conjunction with the embodiment 3 to an embodiment which uses the address circuits as explained in conjunction with the embodiment 2. In this case, as equivalent circuits of four display pixels (11 to 14), the equivalent circuit shown in FIG. 5 is used.

In the above-mentioned respective embodiments, the explanation has been made with respect to the case in which the peripheral circuit (for example, the driving circuit which possesses the shift register or the like) is incorporated in the display panel (integrally formed on the substrate of the display panel). However, the present invention is not limited to such a case and a function of a portion of the peripheral circuit may be constituted using semiconductor chips.

In the above-mentioned respective embodiments, the explanation has been made with respect to the case in which the MOS transistor is used as the thin film transistors. However, an MIS transistor which is broader than the MOS transistor in concept may be used.

Although the invention made by inventors of the present invention is specifically explained based on the above-mentioned embodiments, it is needless to say that the present invention is not limited to the above-mentioned embodiments and various modifications can be made without departing from the gist of the present invention.

What is claimed is:

1. A display device comprising a display panel including a plurality of display pixels, video lines which apply video data to the display pixels, scanning lines which apply a scanning voltage to the display pixels, a video line address circuit, and a scanning line address circuit,
wherein each of the display pixels includes:
a memory part which stores the video data;
a pixel electrode; and
a switching part which selectively applies a first video voltage or a second video voltage which differs from the first video voltage to the pixel electrode in response to the video data stored in the memory part,
wherein in a state that the video data stored in the memory part is held, the memory part includes a first inverter circuit which has an input terminal thereof connected to a first node and an output terminal thereof connected to a second node, and a second inverter circuit which has an input terminal thereof connected to the second node and an output terminal thereof connected to the first node,
wherein each of the display pixels further includes a first switching element which is turned off when a non-selective scanning voltage is applied to the scanning line, and is turned on when a selective scanning voltage is applied to the scanning line and applies the video data which is applied to the video line to the first node, and a second switching element which is connected between the first node and the output terminal of the second inverter circuit, and is turned off when the selective scanning voltage is applied to the scanning line, and is turned on when the non-selective scanning voltage is applied to the scanning line,
wherein the switching part includes a third switching element which has a gate thereof connected to the first node, has a first terminal thereof to which the first video voltage is supplied, and has a second terminal thereof connected to the pixel electrode, and a fourth switching element which has a gate thereof connected to the second node, has a first terminal thereof to which the second video voltage is supplied, and has a second terminal thereof connected to the pixel electrode, and a conductive type of the third switching element and a conductive type of the fourth switching element are equal, and
wherein the video line address circuit selects the display pixel to which the video data is to be written, and the scanning line address circuit selects the scanning line to which the scanning voltage is to be supplied.

2. A display device comprising a display panel including a plurality of display pixels, data lines which apply a data to the display pixels, video lines which is selected as an address inputted the data, scanning lines which apply a scanning voltage to the display pixels, a video line address circuit, and a scanning line address circuit,
wherein each of the display pixels includes:
a memory part which stores the data;
a pixel electrode; and
a switching part which selectively applies a first video voltage or a second video voltage which differs from the first video voltage to the pixel electrode in response to the data stored in the memory part,
wherein in a state that the data stored in the memory part is held, the Memory part includes a first inverter circuit which has an input terminal thereof connected to a first node and an output terminal thereof connected to a second node, and a second inverter circuit which has an input terminal thereof connected to the second node and an output terminal thereof connected to the first node,
wherein each of the display pixels further includes a first switching element which is turned off when a non-selective scanning voltage is applied to the scanning line, and is turned on when a selective scanning voltage is applied to the scanning line and applies the data which is applied to the data line to the first node, and a second switching element which is connected between the first node and the output terminal of the second inverter circuit, and is turned off when the selective scanning voltage is applied to the scanning line, and is turned on when the non-selective scanning voltage is applied to the scanning line,
wherein the switching part includes a third switching element which has a gate thereof connected to the first node, has a first terminal thereof to which the first video voltage is supplied, and has a second terminal thereof connected to the pixel electrode, and a fourth switching element which has a gate thereof connected to the second node, has a first terminal thereof to which the second video voltage is supplied, and has a second terminal thereof connected to the pixel electrode, and a conductive type of the third switching element and a conductive type of the fourth switching element are equal,
wherein the video line address circuit selects the display pixel to which the data is to be written, and the scanning line address circuit selects the scanning line to which the scanning voltage is to be supplied, and
wherein each of the display pixels further includes a fifth switching element which has a gate thereof connected to the video line, has a first terminal thereof to which the data is supplied, and has a second terminal thereof connected to the first switching element.

3. A display device according to claim 1, wherein the video line address circuit and the scanning line address circuit are constituted of rows of n-type MOS transistors and p-type MOS transistors, and
each of gates of the n-type MOS transistors and the p-type MOS transistors is respectively connected with the video line or the scanning line.

4. A display device according to claim 2, wherein the video line address circuit and the scanning line address circuit are constituted of rows of n-type MOS transistors and p-type MOS transistors, and
each of gates of the n-type MOS transistors and the p-type MOS transistors is respectively connected with the video line or the scanning line.

5. A display device according to claim 1, wherein the display device includes a common electrode which faces the pixel electrodes in an opposed manner and the first video voltage is applied to the common electrode.

6. A display device according to claim 2, wherein the display device includes a common electrode which faces the pixel electrodes in an opposed manner and the first video voltage is applied to the common electrode.

7. A display device according to claim 5, wherein the magnitude of the first video voltage and the magnitude of the second video voltage are changed over from each other in a predetermined cycle.

8. A display device according to claim 6, wherein the magnitude of the first video voltage and the magnitude of the second video voltage are changed over from each other in a predetermined cycle.

9. A display device according to claim 1, wherein the switching part includes a third switching element which is turned off when a voltage of the first node assumes a second state and is turned on when the voltage of the first node assumes a first state so as to apply the first video voltage to the pixel electrode, and a fourth switching element which is turned off when a voltage of the second node assumes the second state and is turned on when the voltage of the second node assumes the first state so as to apply the second video voltage to the pixel electrode.

10. A display device according to claim 2, wherein the switching part includes a third switching element which is turned off when a voltage of the first node assumes a second state and is turned on when the voltage of the first node assumes a first state so as to apply the first video voltage to the pixel electrode, and a fourth switching element which is turned off when a voltage of the second node assumes the second state and is turned on when the voltage of the second node assumes the first state so as to apply the second video voltage to the pixel electrode.

11. A display device according to claim 1, wherein the video line address circuit and the scanning line address circuit are integrally formed on the same substrate on which the memory parts of the display panel are formed.

12. A display device according to claim 2, wherein the video line address circuit and the scanning line address circuit are integrally formed on the same substrate on which the memory parts of the display panel are formed.

13. A display device according to claim 1, wherein the display device includes an inverter which generates the second video voltage by inverting the first video voltage.

14. A display device according to claim 2, wherein the display device includes an inverter which generates the second video voltage by inverting the first video voltage.
